(19) United States
(12) Patent Application Publication
(10) Pub. No.: US 2012/0050182 A1
(43) Pub. Date: Mar. 1, 2012

(54) Control signal generating method for input device

(75) Inventor: Chih-Min Liu, Taipei (TW)

(73) Assignee: KYE SYSTEMS CORP., Taipei (TW)

(21) Appl. No.: 12/926,169

(22) Filed: Oct. 29, 2010

(30) Foreign Application Priority Data
Aug. 27, 2010 (TW) 099128961

(51) Int. Cl. G06F 3/041

(52) U.S. Cl. 345/173

(57) ABSTRACT

A control signal generating method for an input device is presented. The input device includes a pointing device and a sensing device, and the pointing device sends an electromagnetic signal to the sensing device. In the method, the electromagnetic signal received by the sensing device has different strengths according to different distances between the pointing device and the sensing device. The strength of the electromagnetic signal may be further converted to a parameter. A user may adjust the distance between the pointing device and the sensing device when operating the pointing device, thereby generating a parameter to control a computer.

### CROSS-REFERENCE TO RELATED APPLICATIONS

This non-provisional application claims priority under 35 U.S.C. §119(a) on Patent Application No(s). 099128961 filed in Taiwan, R.O.C. on Aug. 27, 2010, the entire contents of which are hereby incorporated by reference.

### BACKGROUND OF THE INVENTION

1. Field of the Invention

The present invention relates to a signal generating method, and more particularly to a control signal generating method for an input device.

2. Related Art

Along with popularization of a multimedia computer, the multimedia computer has become a tool of processing work and entertainment for most users. The user may use a mouse, a track ball, a keyboard, or a digital tablet as a peripheral input device giving inputs to the multimedia computer. Among others, it is the manner most satisfying a writing habit of the user that a writing area of the digital tablet is used to input letters or graphs to the multimedia computer.

The digital tablet commonly in the market is used together with a wireless input device, and when a wireless pointing device approaches the digital tablet, an electromagnetic field generated by the wireless pointing device enables the digital tablet to work out a two-dimensional coordinate position of the wireless pointing device in a magnetic coupling manner, and transfer the two-dimensional coordinate position to a computer end.

As functions of the computer become increasingly complicated, the wireless pointing device capable of generating the two-dimensional coordinate position only functions insufficient in operation. In order to improve the convenience of manipulating the wireless pointing device or add more additional functions, more keys are added on the digital tablet in the conventional art, so as to enable the user to perform diversified operations.

However, if more keys are added on the digital tablet, a structure of the digital tablet becomes complicated, a volume is huge, and also a cost is increased. That is to say, a conflict exists between the techniques of keeping a simple structure of the digital tablet and increasing diversity of operation.

### SUMMARY OF THE INVENTION

In view of the above problems, the present invention provides a control signal generating method for an input device. The control signal generating method for the input device comprises the following steps: a pointing device emitting an electromagnetic signal, a sensing device receiving the electromagnetic signal, the sensing device discriminating a position of the pointing device according to the electromagnetic signal, and generating a first control signal according to the position; receiving a trigger command; generating a signal strength value according to a relative distance between the pointing device and the sensing device; and generating a second control signal according to the signal strength value.

Furthermore, the present invention further provides a control signal generating method for an input device, which comprises the following steps: a pointing device emitting an electromagnetic signal, a sensing device receiving the electromagnetic signal, the sensing device discriminating a position of the pointing device according to the electromagnetic signal, and generating a first control signal according to the position; generating a signal strength value according to a relative distance between the pointing device and the sensing device; generating a second control signal according to the signal strength value; and integrating the first control signal and the second control signal, so as to generate a third control signal.

In an embodiment of the present invention, the control parameter generating method may further comprise the following steps: generating a first signal strength value at a first time point; generating a second signal strength value at a second time point; and generating a second control signal according to a difference between the first signal strength value and the second signal strength value.

In another embodiment of the present invention, the control parameter generating method may further comprise the following steps: displaying the signal strength value on a screen; and determining whether the signal strength value is greater than a preset value, so as to generate the second control signal.

In view of the above, through the control signal generating method for the input device according to the present invention, diversity of manipulating the pointing device or the sensing device may be increased without adding additional keys or changing an original structure.

### BRIEF DESCRIPTION OF THE DRAWINGS

The present invention will become more fully understood from the detailed description given herein below for illustration only, and thus are not limitative of the present invention, and wherein:

FIG. 1 is a schematic three-dimensional view of a pointing device according to the present invention;

FIG. 2 is schematic outside view of a pointing device and a sensing device according to the present invention;

FIG. 3 is a flow chart of a control parameter generating method according to a first embodiment of the present invention;

FIGS. 4A, 4B, and 4C are schematic operation views of a pointing device according to the present invention;

FIG. 5 is a flow chart of a control parameter generating method according to a second embodiment of the present invention;

FIG. 6 is a flow chart of a control parameter generating method according to a third embodiment of the present invention;

FIG. 7 is a flow chart of a control parameter generating method according to a fourth embodiment of the present invention;

FIG. 8 is a flow chart of a control parameter generating method according to a fifth embodiment of the present invention;

FIG. 9 is a flow chart of a control parameter generating method according to a sixth embodiment of the present invention; and

FIG. 10 is a flow chart of a control parameter generating method according to a seventh embodiment of the present invention.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

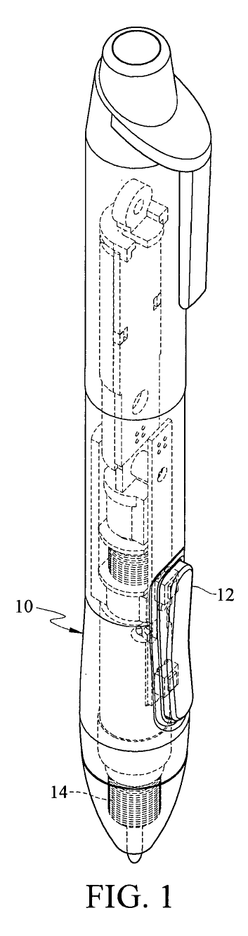

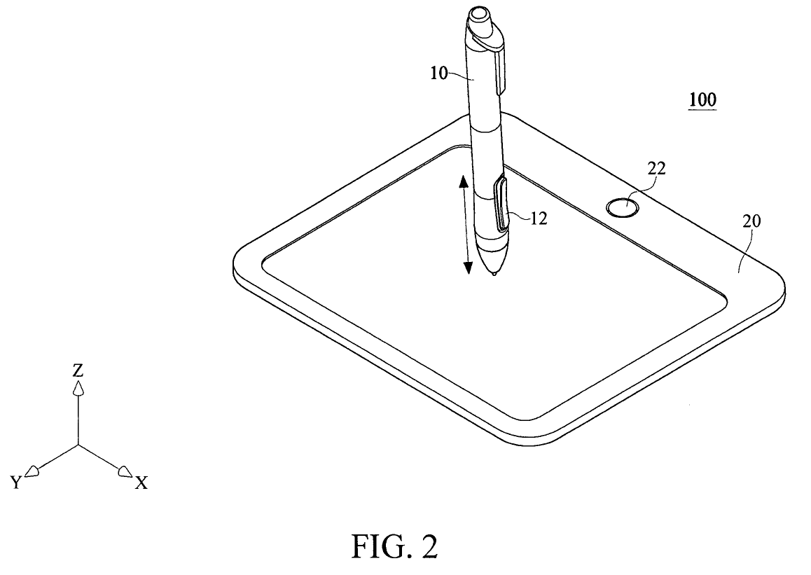

Referring to FIGS. 1 and 2, FIG. 1 is a schematic three-dimensional view of a pointing device according to the present invention, and FIG. 2 is a schematic outside view of a pointing device and a sensing device according to the present invention.

An input device 100 comprises a pointing device 10 and a sensing device 20. The pointing device 10 may have a pen profile to facilitate a user to operate. The pointing device 10 comprises a key 12 and a sensing coil 14. The sensing coil 14 generates an electromagnetic signal.

The sensing device 20 may be a flat panel and has a plurality of receiver coils, an analog-to-digital converter, and a microprocessor (not shown). The receiver coils may receive the electromagnetic signal generated by the sensing coil 14, and the electromagnetic signal after being converted by the analog-to-digital converter to the digital signal is transferred to the microprocessor for being operated. In an embodiment of the present invention, the sensing device 20 may be a display screen, and more particularly a touch screen. The user may directly manipulate the sensing device 20 to operate a computer system.

The pointing device 10 is provided with a key 12 or the sensing device 20 is provided with a key 22. When the key 12 or the key 22 is pressed, a trigger signal is generated.

The user may operate the pointing device 10 on a sensing device 20, and the sensing device 20 may detect the electromagnetic signal emitted by the pointing device 10. The sensing device 20 works out a relative coordinate position of movement of the pointing device 10, and then transfers the relative coordinate position of movement to a computer end.

The farther the pointing device 10 is from the sensing device 20, the weaker a strength of the electromagnetic signal detected by the sensing device 20 will be. The nearer the pointing device 10 is from the sensing device 20, the stronger the strength of the electromagnetic signal detected by the sensing device 20 will be. Therefore, the user may adjust the strength of the electromagnetic signal detected by the sensing device 20 by changing the position between the pointing device 10 and the sensing device 20. The strength of the electromagnetic signal is then converted into the control signal and is transferred to the computer end for being controlled.

Furthermore, when the pointing device 10 contacts with an object and when the pointing device 10 is exerted with a downward pressure, the sensing coil 14 produces deformation due to the extrusion, thereby changing a frequency of the electromagnetic signal generated by the sensing coil 14. Therefore, the frequency of the electromagnetic signal received by the sensing device 20 offsets. The frequency offset is converted into the control signal, so as to be transferred to the computer end for being controlled.

That is to say, the user may manipulate the pointing device 10 to move up and down in a direction perpendicular to the sensing coil 14, for the control of the computer.

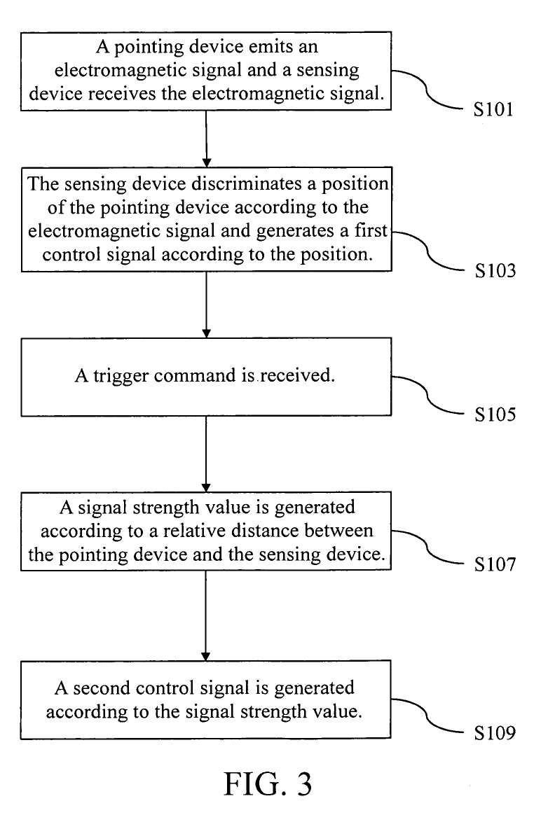

Referring to FIG. 3, a flow chart of a control parameter generating method according to a first embodiment of the present invention is shown.

In Step S101, a pointing device 10 emits an electromagnetic signal by using a sensing coil 14, and a sensing device 20 respectively receives the electromagnetic signal by using a plurality of receiver coils. The electromagnetic signal emitted by the pointing device 10 has a constant strength. However, the strength of the signal received by the sensing device 20 may be changed due to a distance between the pointing device 10 and the sensing device 20.

In Step S103, the sensing device 20 discriminates a position of the pointing device 10 according to the electromagnetic signal. In addition to the description of Step S101, the plurality of coils of the sensing device 20 respectively receive the electromagnetic signal of different strengths due to the different distances between the coils and the pointing device 10. The sensing device 20 can discriminate the position of the pointing device 10 according to the different strengths of the electromagnetic signal. Since the plurality of coils may be respectively disposed on the sensing device 20 in two directions (for example, an X-axis and a Y-axis in FIG. 2), the sensing device 20 may discriminate the positions of the pointing device 10 on the X-axis and the Y-axis, so as to generate one two-dimensional coordinate.

After discriminating the position of the pointing device 10 according to the strength of the electromagnetic signal, the sensing device 20 converts the position to a first control signal. Since the first control signal represents one two-dimensional coordinate, the first control signal may be transferred to a computer host to control movement of a cursor.

In Step S105, a trigger command is received. The trigger command may be generated when a button (for example, a key 12 in FIG. 1) of the pointing device 10 is pressed or may be generated when a button of the sensing device 20 is pressed.

In Step S107, after receiving the trigger command, the sensing device 20 generates a signal strength value according to a relative distance between the pointing device 10 and the sensing device 20. The nearer the relative distance between the pointing device 10 and the sensing device 20 is, the stronger the strength of the signal received by the sensing device 20 will be. On the contrary, the farther the relative distance between the pointing device 10 and the sensing device 20 is, the weaker the strength of the signal received by the sensing device 20 will be. The relative distance represents the position of the pointing device 10 on a Z-axis in FIG. 2.

In Step S109, a second control signal is generated according to the signal strength value. In addition to the above description, since the signal strength value is corresponding to the relative distance, the signal strength value may be converted to the second control signal. The second control signal contains information of the relative distance, that is to say, the second control signal has one dimension. The first control signal may be transferred to the computer for one-dimensional control, for example, control of volume, image scaling, or scroll bar scrolling.

In summary, when being used together with the pointing device 10, the sensing device 20 may generate the first control signal or the second control signal under different operation modes. Therefore, under the condition that no additional key is added or the pointing device 10 remains unchanged, the convenience of manipulating the pointing device 10 is greatly improved.

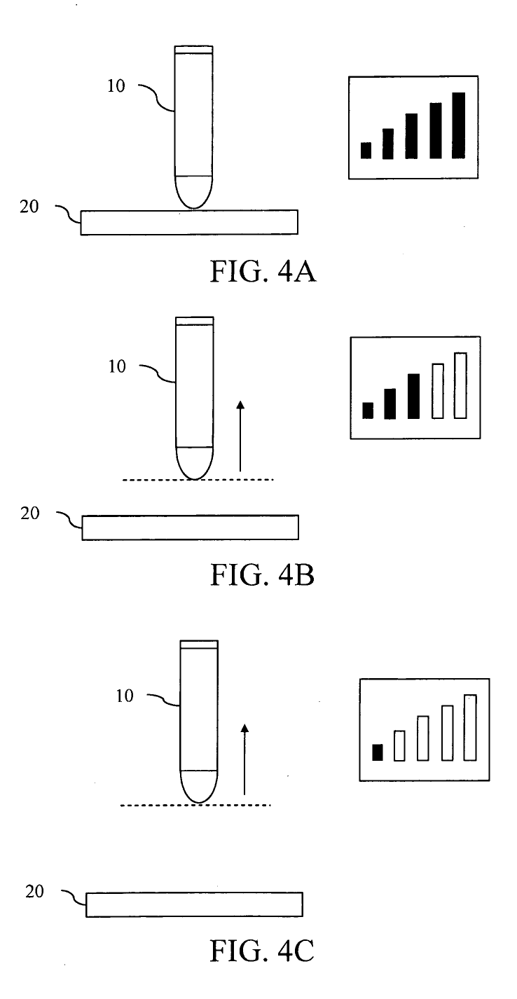

Referring to FIGS. 4A, 4B, and 4C, schematic operation views of the pointing device according to the present invention are shown. In the figures, the user adjusts the volume of the computer system according to the distance between the pointing device 10 and the sensing device 20.

In FIG. 4A, the distance between the pointing device 10 and the sensing device 20 is minimum, and the corresponding volume is maximum.

In FIG. 4B, the distance between the pointing device 10 and the sensing device 20 is a middle value, and the corresponding volume is moderate.

In FIG. 4C, the distance between the pointing device 10 and the sensing device 20 is maximum, and the corresponding volume is minimum.

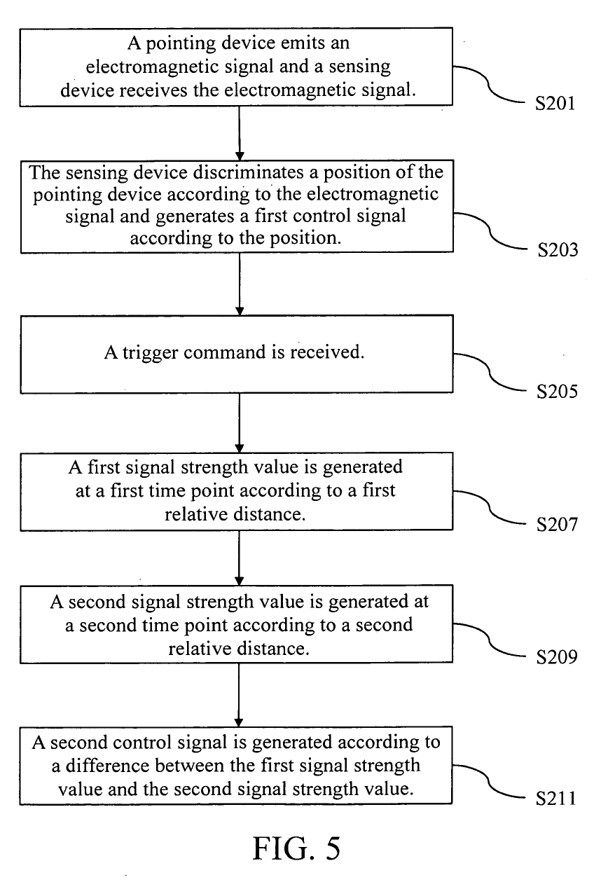

Referring to FIG. 5, a flow chart of the control parameter generating method according to a second embodiment of the present invention is shown.

Steps S201, S203, and S205 are the same as Steps S101, S103, and S205, so the details will not be repeated herein.

In Step S207, a first signal strength value is generated at a first time point according to a first relative distance. The first time point may be the time point when the key 12 of the pointing device 10 is pressed. The manner of generating the first signal strength value is similar to that of Step S107.

In Step S209, a second signal strength value is generated at a second time point according to a second relative distance. The second time point may be the time point when the key 12 of the pointing device 10 is released after being pressed. The manner of generating the second signal strength value is similar to that of Step S107.

In Step S211, after the first signal strength value and the second signal strength value are generated, a difference between the first signal strength value and the second signal strength value may represent a variation between the first relative distance and second relative distance. Thereafter, the second control signal is calculated and generated according to the difference between the first signal strength value and the second signal strength value.

With the control of the differences of the former and latter signal strength values, the pointing device is controlled more precisely.

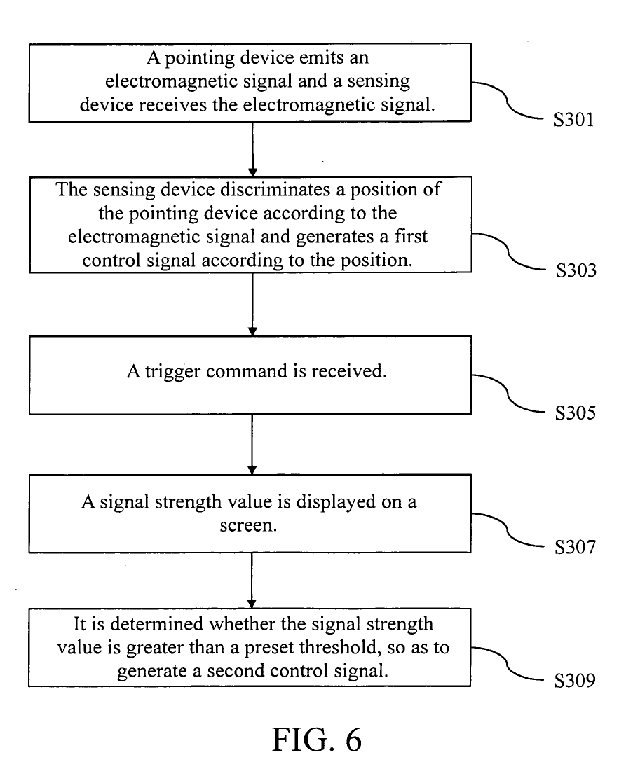

Referring to FIG. 6, a flow chart of the control parameter generating method according to a third embodiment of the present invention is shown.

Steps S301, S303, and S305 are the same as Steps S101, S103 and S205, so the details will not be repeated herein.

In Step S307, the signal strength value may be displayed on a screen. The user may adjust the relative distance between the pointing device 10 and the sensing device 20 according to the signal strength value displayed on the screen.

In Step S309, the sensing device 20 may determine whether the signal strength value is greater than a preset threshold. If the signal strength value is greater than the threshold, a second control signal is generated. At this time, the second control signal represents an instruction, for example, an instruction of double left clicking the mouse. In this embodiment, it is also acceptable that if the signal strength value is smaller than the threshold, a second control signal is generated.

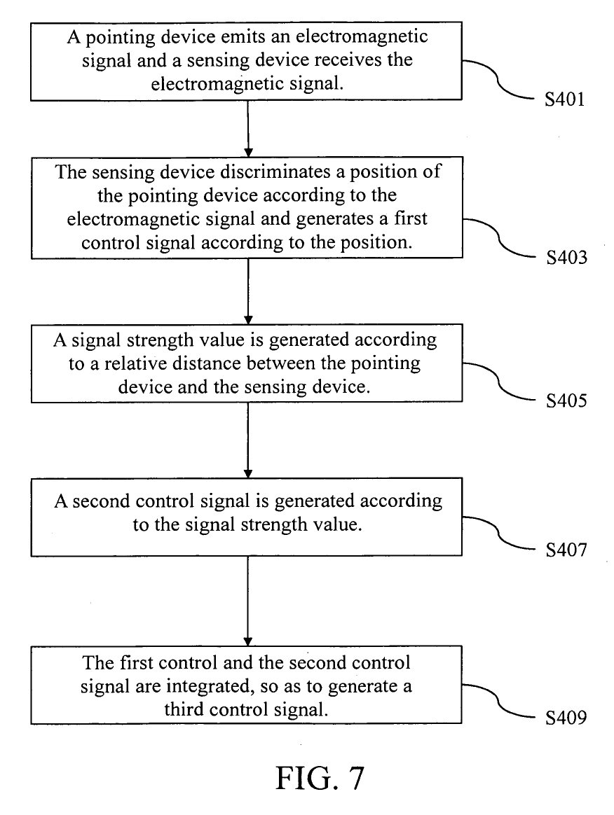

Referring to FIG. 7, a flow chart of the control parameter generating method according to a fourth embodiment of the present invention is shown.

Steps S401 and S403 are the same as Steps S101 and S103, so the details will not be repeated herein.

In another aspect, Steps S405 and S407 are the same as Steps S107 and S109, so the details will not be repeated herein.

In this embodiment, the sensing device 20 may generate the second control signal without receiving the trigger command. That is to say, the sensing device 20 can generate the first control signal and the second control signal at the same time according to a relative displacement and the relative distance.

In Step S409, the first control signal and the second control signal are integrated, so as to generate a third control signal. In addition to the description of the first embodiment, the first control signal has two dimensions, and the second control signal has one dimension. Therefore, the third control signal may have three dimensions. The third control signal may be provided to the computer for the three-dimensional control.

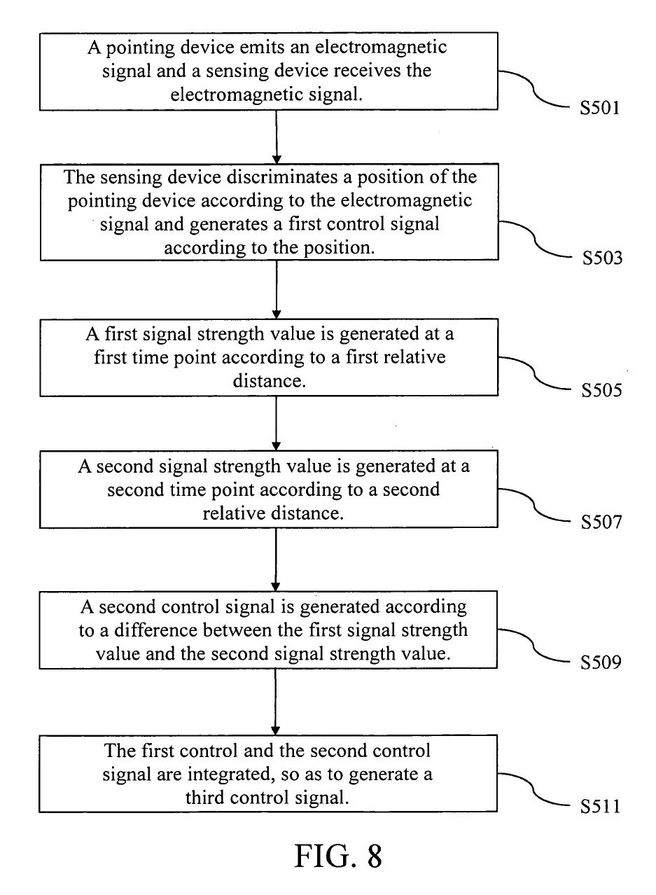

Referring to FIG. 8, a flow chart of the control parameter generating method according to a fifth embodiment of the present invention is shown.

Steps S501 and S503 are the same as Steps S101 and S103, so the details will not be repeated herein.

Steps S505, S507, and S509 are the same as Steps S207, S209, and S211, in which the second control signal is generated according to the difference between the signal strength values at the different time points (the first time point and the second time point), that is, the variation of the relative distance.

Step S511 is the same as Step S409. The sensing device 20 can generate the first control signal and the second control signal at the same time according to the relative displacement and the variation of the relative distance, and integrate the first control signal and the second control signal, so as to generate a third control signal.

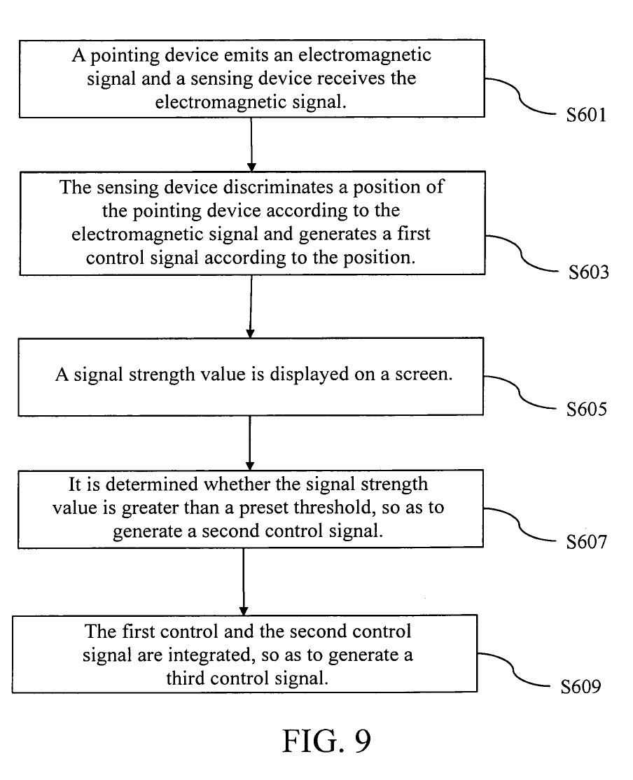

Referring to FIG. 9, a flow chart of the control parameter generating method according to a sixth embodiment of the present invention is shown.

Steps S601 and S603 are the same as Steps S101 and S103, so the details will not be repeated herein.

In Step S605, the signal strength value may be displayed on the screen. The user may adjust the relative distance between the pointing device 10 and the sensing device 20 according to the signal strength value displayed on the screen.

In Step S607, the sensing device 20 may determine whether the signal strength value is greater than a preset threshold. If the signal strength value is greater than the threshold, a second control signal is generated. At this time, the second control signal represents an instruction, for example, an instruction command of double left clicking the mouse. In this embodiment, it is also acceptable that if the signal strength value is smaller than the threshold, a second control signal is generated.

In Step S609, the first control signal and the second control signal are integrated, so as to generate a third control signal. The difference between Step S609 and Step S309 lies in that the second control signal here represents an instruction.

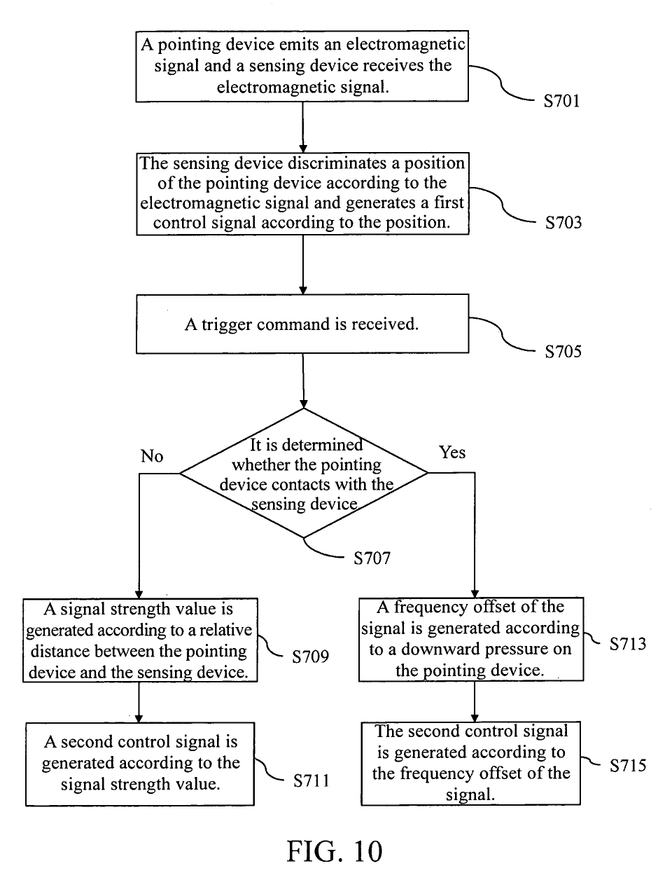

Referring to FIG. 10, a flow chart of the control parameter generating method according to a seventh embodiment of the present invention is shown.

Steps S701, S703, and S705 are the same as Steps S101, S103, and S105, so the details will not be repeated herein.

In Step S707, it is determined whether the pointing device 10 contacts with the sensing device 20. In the determination method, based on that the pointing device 10 detects whether one end thereof is exerted with a pressure, when the pointing device 10 detects that it contacts with the sensing device 20, Steps S713 and S715 are executed, and when the pointing device 10 detects that it does not contact with the sensing device 20, Steps S709 and S711 are executed.

Steps S709 and S711 are the same as Steps S107 and S109, in which the second control signal is generated according to the different strengths of the electromagnetic signal. That is to say, the user may adjust a second control parameter by changing the relative distance between the pointing device 10 and the sensing device 20.

In Step S713, a frequency offset of the signal is generated according to the downward pressure on the pointing device 10. Since when the user exerts the downward pressure on the pointing device 10, length of the sensing coil 14 of the pointing device 10 is changed, and the frequency of the electromagnetic signal emitted by the sensing coil 14 is changed accordingly, the electromagnetic signal frequency received by the sensing device 20 offsets.

In Step S715, the sensing device 20 may generate the second control signal according to the frequency offset of the electromagnetic signal. That is to say, the user may adjust the second control signal by changing the downward pressure on the pointing device 10.

The respective second control signal generated in Step S711 and Step S715 may be a positive signal and a negative signal, that is, the second control signal generated in Step S711 is a positive number, and the second control signal generated in Step S715 is a negative number. Therefore, according to whether the pointing device 10 contacts with the sensing device 20, when the pointing device 10 does not contact with the sensing device 20, the user can turn up the volume (or enlarge the image) by increasing the relative distance between the pointing device 10 and he sensing device 20, and when the pointing device 10 contacts with the sensing device 20, the user may turn down the volume (or reduce the image) by increasing the downward pressure on the pointing device 10.

In view of the above, through the control signal generating method for the input device according to the present invention, diversity of manipulating the pointing device or the sensing device may be increased without adding additional keys or changing an original structure.

What is claimed is:

1. A control signal generating method for an input device, comprising:
a pointing device emitting an electromagnetic signal, a sensing device receiving the electromagnetic signal, the sensing device discriminating a position of the pointing device according to the electromagnetic signal, and generating a first control signal according to the position;
receiving a trigger command;
generating a signal strength value according to a relative distance between the pointing device and the sensing device; and
generating a second control signal according to the signal strength value.

2. The control signal generating method for the input device according to claim 1, further comprising:
generating the trigger command, when a button of the pointing device is pressed.

3. The control signal generating method for the input device according to claim 1, further comprising:
generating the trigger command, when a button of the sensing device is pressed.

4. The control signal generating method for the input device according to claim 1, wherein in the steps of generating the signal strength value according to the relative distance between the pointing device and the sensing device and generating the second control signal according to the signal strength value, the method further comprises:
generating a first signal strength value at a first time point according to a first relative distance;
generating a second signal strength value at a second time point according to a second relative distance; and
generating the second control signal according to a difference between the first signal strength value and the second signal strength value.

5. The control signal generating method for the input device according to claim 1, wherein after the step of generating the signal strength value according to the relative distance between the pointing device and the sensing device, the method further comprises:
displaying the signal strength value on a screen; and
determining whether the signal strength value is greater than a preset value, so as to generate the second control signal.

6. An control signal generating method for an input device, comprising:
a pointing device emitting an electromagnetic signal, a sensing device receiving the electromagnetic signal, the sensing device discriminating a position of the pointing device according to the electromagnetic signal, and generating a first control signal according to the position;
generating a signal strength value according to a relative distance between the pointing device and the sensing device;
generating a second control signal according to the signal strength value; and
integrating the first control signal and the second control signal, so as to generate a third control signal.

7. The control signal generating method for the input device according to claim 6, further comprising:
generating a trigger command, when a button of the pointing device is pressed, so as to generate the signal strength value according to the relative distance between the pointing device and the sensing device.

8. The control signal generating method for the input device according to claim 6, further comprising:
generating a trigger command, when a button of the sensing device is pressed, so as to generate the signal strength value according to the relative distance between the pointing device and the sensing device.

9. The control signal generating method for the input device according to claim 6, wherein in the steps of generating the signal strength value according to the relative distance between the pointing device and the sensing device and generating the second control signal according to the signal strength value, the method further comprises:
generating a first signal strength value at a first time point;
generating a second signal strength value at a second time point; and
generating the second control signal according to a difference between the first signal strength value and the second signal strength value.

10. The control signal generating method for the input device according to claim 6, wherein after the step of generating the signal strength value according to the relative distance between the pointing device and the sensing device, the method further comprises:
displaying the signal strength value on a screen; and
determining whether the signal strength value is greater than a preset value, so as to generate the second control signal.
